(19) United States
(12) Patent Application Publication
(10) Pub. No.: US 2019/0201886 A1
(43) Pub. Date: Jul. 4, 2019

(54) MIXTURE FOR MAKING A CATALYST CARRIER AND PROCESS FOR MAKING THE MIXTURE

(71) Applicant: Saint-Gobain Ceramics & Plastics, Inc., Worcester, MA (US)

(72) Inventor: Thomas Szymanski, Hudson, OH (US)

(73) Assignee: Saint-Gobain Ceramics & Plastics, Inc., Worcester, MA (US)

(21) Appl. No.: 16/229,442

(22) Filed: Dec. 21, 2018

Related U.S. Application Data
(60) Provisional application No. 62/612,427, filed on Dec. 30, 2017.

(51) Int. Cl. B01J 37/04; B01J 21/04; B01J 35/02; B01J 37/00; B01J 37/08; B01J 27/224; C04B 35/10; C04B 35/626; C04B 35/63

(52) U.S. Cl. CPC B01J 37/04; B01J 21/04; B01J 35/026; B01J 37/0009; B01J 37/08; B01J 27/224; C04B 2235/6021; C04B 35/62625; C04B 35/62655; C04B 35/6267; C04B 35/63; C04B 2235/3217; C04B 2235/3826; C04B 35/10

(57) ABSTRACT

A mixture for making a ceramic carrier that uses a first powder that has a fracture factor of 15.0 or greater and a second powder that has a fracture factor of 14.9 or less. The second powder may reduce the cost to manufacture the carrier by effectively reducing the mixing time needed to produce a mixture that can be extruded.

### CROSS-REFERENCE TO RELATED APPLICATION

This application claims the benefit of U.S. Provisional Application No. 62/612,427 filed Dec. 30, 2017.

### FIELD OF THE INVENTION

This invention generally relates to processes for manufacturing ceramic catalyst carriers. More particularly, this invention is concerned with alumina based carriers and catalyst made therefrom that are useful in the production of an olefin oxide, a 1,2-carbonate, or an alkanolamine.

### BACKGROUND OF THE INVENTION

In olefin epoxidation, feedstocks containing an olefin and an oxygen source are contacted with a catalyst disposed within a reactor under epoxidation conditions which results in the production of olefin oxide and typically includes unreacted feedstock and combustion products. The catalyst usually comprises a catalytically active material, such as silver, deposited on a plurality of ceramic pellets which may be referred to as carrier.

A key driver behind the technical efforts to provide an improved catalyst has been to reduce the manufacturing cost of a reactor's final product (i.e. an olefin oxide) such as ethylene oxide. The cost of manufacturing can be impacted, both positively and negatively, in several ways which may be interrelated and thus complicated to isolate and improve upon. For example, the cost of the final product can be reduced if the selectivity of the reaction can be increased without a corresponding increase in the reactor's operating temperature. As used herein, selectivity is an indication of the proportion, usually represented by a percentage, of the converted material or product which is alkene oxide. If the carrier and catalyst can be changed so that the selectivity of the reactor is improved, then a higher percentage of the reactants are converted to the desired final product relative to the percentage of reactants converted with a previously used catalyst. The cost of the final product may also be reduced if the reactor's operating temperature can be reduced relative to another carrier that has generally equivalent or lower selectivity. Another tactic to reduce the cost of the final product is to improve the longevity of the catalyst which means that the reactor can be operated for longer periods of time before the selectivity and/or activity of the catalyst declines and/or the temperature increases to an unacceptable level which requires the reactor to be stopped so that the catalyst can be replaced. Stopping the reactor to replace the catalyst inherently incurs expenses that add to the cost of the final product.

In addition to improving the performance of the catalyst in the reactor, yet another way to reduce the cost of the final product is to reduce the cost of the carrier which is a fundamental cost component of the catalyst. Because the cost of the carrier is a significant contributor to the cost of the catalyst any cost reduction improvement in the process used to manufacture the carrier can reduce the cost of the catalyst which reduces the cost of the reactor's final product.

Processes for making carrier and catalysts are described, for example, in: U.S. Pat. No. 6,831,037; U.S. Pat. No. 7,825,062; U.S. Pat. No. 9,073,035; US 2016/0354760. More specifically, in paragraph [0091] of 2016/0354760 the inventor described a process in which the following ingredients were added under constant stirring: binder was dispensed in water; milled and/or unmilled alpha alumina powder were added; one or more burn-outs could be added and lubricant was added. The mixture was then extruded using a 2″ Bonnot extruder with a single die to produce extrudate in the shape of hollow cylinders. No teachings are provided regarding the length of time the ingredients are stirred. Similarly, there is no description that would teach a person skilled in the art when the mixture had reached an optimum or even workable consistency for processing through subsequent operations such as the extrusion. In U.S. Pat. No. 5,100,859, beginning on column 4, line 43, the inventors describe combining several dry ingredients; including alpha alumina, Zirconia, calcium silicate, walnut shell flour, boric acid and polyolefin oxide. The dry ingredients were then mixed for 45 seconds. Enough water was then added to give an extrudable mixture and mixing was continued for a further 4 minutes. At that point, “5% (based on the weight of the ceramic components) of vaseline was added and the mixing was continued for a further 3 minutes.” The material was then extruded, dried to less than 2% moisture and fired in a tunnel kiln to a maximum temperature of 1390° C. for about four hours. These references do not identify the problem which is addressed with the invention described below and thus they do not describe how to solve the problem identified by this inventor. Specifically, the problem to be solved is that certain “wet” mixtures that are used to make carriers have been found to take 15, 20 or even 30 minutes of active mixing to provide “an extrudable mixture” as that phrase was used in U.S. Pat. No. 5,100,859. The increased mixing time decreases the productivity of the carrier manufacturing process. Therefore, ways to reduce the mixing time are needed.

### SUMMARY

Embodiments of the present invention provide a reduction in mixing time of the wet mix used to make sintered alumina based ceramic components such as carriers for epoxidation reactions. The reduction in mixing time of the wet mix is achieved by mixing a first comminuted material comprising at least 90 weight percent alumina with a small percentage (based on weight percent) of a second comminuted material that has a higher fracture factor than the alumina material. The second material reduces the time needed to achieve an extrudable mixture.

In one embodiment, the present invention is a mixture that is useful in the manufacture of a ceramic carrier. The mixture comprises a first comminuted material, which may be described herein as a first powder, and a second comminuted material, which may be referred to herein as a second powder. The first powder comprises at least 80 weight percent alumina and has a fracture factor of 15.0 or higher. The second powder has a fracture factor of 14.9 or lower. The weight ratio of the first powder to the second powder is between 50:1 and 1000:1.

Another embodiment relates to a process for manufacturing a ceramic component. The process may comprise the following steps. Providing a first powder comprising a plurality of individual free flowing particles that have a fracture factor equal to or more than 15.0. Providing a second powder comprising a plurality of individual free flowing particles that have a fracture factor equal to or less than 14.9. The weight ratio of the first powder to the second powder is between 50:1 and 1000:1. Mixing the powders for an initial period of time (T₁) thereby forming a first mixture which has a moisture content less than 2 weight percent based on the total weight of the first mixture.

Yet another embodiment relates to a process for manufacturing a ceramic component. The process may comprise the following steps. Providing a first material comprising a plurality of individual free flowing particles that have a fracture factor equal to 15.0 or more. Providing a second material comprising a plurality of individual free flowing particles that have a fracture factor equal to 14.9 or less. The weight ratio of the first powder to the second powder is between 50:1 and 1000:1. Mixing the powders for an initial period of time (T₁) thereby forming a first mixture. The moisture content of the first mixture is less than 2% based on the total weight of the first mixture. Adding water and at least one component selected from the group consisting of bond materials, pore formers and extrusion aids to the first mixture thereby forming a composition. Mixing the composition for a second period of time (T₂) thereby forming a wet mixture that has a final coil value. Wherein the second mixing time (T₂) is at least 10 percent less than the time needed to mix an identical wet mixture to the same final coil value except that the identical wet mixture contains an equivalent weight of the first powder in place of the second powder.

### BRIEF DESCRIPTION OF THE DRAWINGS

FIG. 1 is a partial cross-sectional view of a coil measuring apparatus; and

FIG. 2 is a perspective drawing of a dual asymmetric centrifugal mixer.

### DESCRIPTION

The description provided herein is intended to provide a skilled artisan with the ability to understand and practice the claimed invention. The specific embodiments describe how the invention can be practiced but should not be interpreted as limiting the scope of the claimed invention. In the specification, including the abstract and detailed description, the numerical values cited therein should be read as modified by the term “about” unless the specification already contains this modifier or specifically teaches to the contrary. In addition, ranges of values are intended to include each and every value in the range including the end points. For example, “equal to or less than 8” should be read as disclosing 8 and every possible number less than 8 such as 7.5, 6.2 and 5.9. Similarly, the phrase “equal to or greater than 9” should be read as disclosing 9 and higher values such as 9.5, 10.7 and 13.1.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise,

Processes for manufacturing porous ceramic carriers may include several steps and numerous processing variables. The process begins with the selection of materials that will ultimately be incorporated into the ceramic carrier as well as numerous materials that will be removed or driven off during the manufacturing process. The primary component of the finished carrier is alumina.

A carrier's chemical composition may be influenced by several factors including impurities in the raw materials used to make the carriers. An example of a common raw material is alumina, such as alpha alumina, in powder form which is a well-known ingredient for manufacturing catalysts for the production of ethylene oxide and other epoxidation reactions. The impurities in the alpha alumina may depend on the process used to manufacture the alpha alumina. Another class of raw materials known as bond materials typically contains a mixture of elements and compounds that serve to bind the particles of alumina powder into discreet, self-supporting greenware or as a sintered carrier. The phrase “bond material” may include temporary bond material and/or permanent bond material. Temporary bond material, such as polyolefin oxides, celluloses and substituted celluloses, including methylcellulose, starch, ethylcellulose and carboxyethylcellulose, typically enable the greenware to remain intact during the carrier manufacturing process. In contrast to temporary bond materials, permanent bond material usually remains a part of the carrier after it has been sintered. Examples of permanent bond materials include alkaline earth metal to compounds and alkali metal compounds. Preferably, the alkaline earth metal compounds include silicates such as magnesium silicate, calcium silicate and barium silicate. Unfortunately both the temporary bond materials and the permanent bond materials may contain one or more impurities that negatively impact the performance of the catalyst. Another class of raw materials is commonly known as pore formers which are used to induce a desired amount of porosity having a certain pore size distribution. The pore formers are typically removed from the carrier during the sintering of the carrier. The pore formers may be naturally occurring material or manufactured materials. An example of a naturally occurring material is comminuted shells of nuts such as pecan, cashew, walnut, peach, apricot and filbert which may be referred to herein as coarse pore formers. Examples of synthetic materials are polypropylene and/or polyethylene. The quantities and varieties of chemical impurities in the naturally occurring materials are inherently more variable than the quantities and varieties of chemical impurities in the manufactured bond material. Consequently, the residue that remains in a carrier after the naturally occurring pore material has been burned out during sintering may contain a variable number of impurities that can adversely impact the selectivity and longevity of the catalyst. Depending on the combinations and concentrations of the impurities, the impurities may only slightly or, in contrast, significantly impact the performance of the catalyst made therefrom. Other raw materials used to manufacture carriers are fluids such as solvents and extrusion aids. Water, particularly de-ionized water, is the most common solvent. The amount of water used in a particular mix is adjusted to achieve a desired flowability through an extrusion die which will be defined herein as the mix's “coil”. Typical quantities of water vary from 10 weight percent to 60 weight percent based on the weight of the alumina. Examples of suitable extrusion aids include petroleum jelly, grease, polyolefin oxides and polyethylene glycol.

A carrier manufacturing process can be generally described as comprising the following steps: dry mixing, wet mixing, extrusion, drying and calcination. These process steps are executed sequentially although one or more steps may be performed on a single machine. For example, dry mixing and then wet mixing may be done in one mixing apparatus. While each step in the process requires a finite amount of time which is usually predetermined and therefore defined in the manufacturing instructions, the length of time that the wet mixing step must he performed can be highly variable because the wet mix may need to have a defined malleable characteristic in order for the mix to be processed smoothly through the extruder. In this specification, the malleable characteristic is defined as “coil” and the process for determining the coil of a wet mixture will be described below.

The “coil” of a mixture is determined using a single speed extrusion pressure test to characterize the rheology of a mixture which is indicative of the mixture's suitability for extrusion. The target coil value or range of values will be different for different materials and for different extruders, extruder die dimensions and tooling set-ups. For example, an alumina based formulation may have an optimum coil range for good extrusion behavior of 250 to 300 KPa, with a target of 275 KPa. If the measured pressure is within this range, the mixture should extrude in a suitable manner. If the coil value is higher, often an adjustment can be made to lower the value by adding water. If the coil value is below this range, the mix may be “too wet” and may not be suitable for good extrusion. Even for a standard known formulation, just adding a standard amount of water does not always give the same coil value due to raw material variations and other factors. Water level adjustments may be needed to keep the coil value within the target range so that extrusion remains consistent from mix to mix.

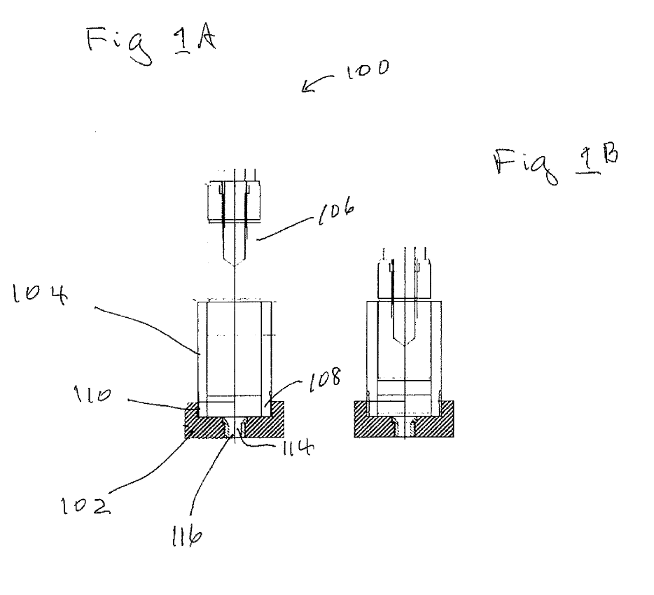

Shown in FIG. 1A is a cross-sectional drawing of a die and plunger subassembly 100 that can be used to measure the coil of a wet mixture. The subassembly includes base 102, barrel 104 and plunger 106. One end 108 of to barrel 104 fits into a recess 110 in base 102. External threads on the barrel engage internal threads in the base. Base 102 has a centrally located hole into which die 114 is inserted. Die 114 has a centrally located hole 116. The barrel has an inside diameter of 41.6 mm and an inner height of 88.5 mm. The top and bottom surfaces of the barrel are perpendicular to the length of the barrel. Plunger 106 is has an outside diameter of 40.6 mm which provides minimum clearance between the inside diameter of the barrel and the outside diameter of the plunger.

To determine the coil of a wet mixture, the wet mixture is packed in the barrel to a depth of about 80 to 85 mm. Plunger 106 is inserted into one end of the barrel and the plunger is manually pushed to slightly compact the wet mixture in the barrel. The die and plunger subassembly with the wet mixture packed therein is placed between a hydraulic press' (not shown) top platen and bottom platen. The bottom platen includes a centrally located hole that aligns with the hole in the die. A pressure gauge (not shown) is used to show the pressure applied by the press to the subassembly. To determine the coil of the wet mixture, the top platen is lowered at a constant speed of 12.7 mm/min which pushes the plunger through the barrel and forcefully extrudes the wet mixture through the die. As the wet mixture is extruded through the die the pressure gauge is observed and the mid-run value is recorded. The mid-run value is the pressure reading on the pressure gage when the plunger is halfway through the barrel. FIG. 1B shows the position of the die and plunger subassembly after the plunger has forced the mixture through the die.

In many commercial carrier manufacturing processes, such as the one described in U.S. Pat. No. 5,100,859, the mixture used to make the carrier includes one or more alumina powders, other inorganic compounds, organic compounds and one or more liquids. During the dry mixing and wet mixing steps the particles of alumina powder may grind the organic and other inorganic ingredients. In the field of porous ceramic carriers, the grinding may be referred to as “working” the mix. The length of time that the wet mixture must be worked to achieve a desirable coil value may be influenced by the following variables. First, the size and shape of the alumina particles can directly impact the coil. For example, alumina particles that are generally spherical will tend to flow through an extruder with much less pressure and in less time than a similar quantity of alumina particles that have an angular or flake like shape. Second, the weight percent of alumina as a percentage of the wet mixture's total weight may be a significant factor in determining how long the wet mixture must be worked in the wet mixing step. A third factor that could influence the time needed to achieve a desired coil value is the fracture factor values of the other ingredients. The method to determine a material's fracture factor will be described below. If the alumina powder has a lower fracture factor than the other materials in the mixture then the alumina particles may act as grinding media that physically shears the other ingredients to reduce the coil to the desired value. Yet another factor to consider is the weight percent of water as a percentage of the wet mixture's total weight. A sufficient quantity of water must be added to the mixture's dry ingredients to form a manually pliable mixture. If too little water is added the mixture will be too dry to process through the extruder. However, if too much water is added the mixture will be too fluid to flow through the extruder and form shaped greenware bodies with sufficient strength to survive the calcination process. As used in the field of forming ceramic porous carriers, “greenware bodies” is the phrase used to identify wet mixture components after forming, such as extrusion, and before sintering.

To address the problem of how to reduce the cost of the carrier, and therefore reduce the final cost of the olefin oxide, the inventor of this application focused on reducing the time dedicated to the wet mixing step. In commercial operation, the wet mixing step may be interrupted to allow for the safe addition of additional ingredients to the mixer. If the wet mixing step is interrupted, then the wet mixing time is determined by adding together the time between first starting to mix the ingredients to which water or another fluid has been added and the interruption plus the time from restarting the wet mixing until the wet mixing step is completed. The time that the operation of the mixer is interrupted to the time that the mixer is restarted is not counted as part of the wet mixing time. The wet mixing step may include one or more interruptions. As indicated above, one way to reduce the time needed for the wet mixing step is to reduce the percentage of alumina in the wet mixture. Another way to reduce the time needed for the wet mixing step is to increase the weight percentage of water. Unfortunately both of these changes to the wet mixture's formula resulted in carriers that were either too weak to resist crushing during normal processing or the wet mixture was too soft and pliable to be processed through the extruder.

To avoid these problems and to reduce the time needed for the wet mixing step, the inventor identified materials that could serve as in situ fracturing media which would facilitate working of the wet mixture to the desired coil value in less time than otherwise identical mixtures that did not have the in situ fracturing media. Furthermore, the fracturing media had to be inert relative to: (1) the other ingredients in the mixture; (2) the materials used in the catalyst manufacturing process; and (3) the materials used in the olefin oxide manufacturing process.

To act as an effective in situ fracturing media, the fracture factor of the alumina powder, which may be referred to herein as a first powder, should be less than the fracture factor of the in situ fracturing media, which may be referred to herein as a second powder. In one embodiment the ratio of the first powder's fracture factor to the second powder's fracture factor is between 100.0:1.0 and 1.1:1.0. In other embodiments the ratio may be between: 50.0:1.0 and 1.2:1.0; 25.0:1.0 and 1.5:1.0; 20.0:1.0 and 2.0:1.0. Intermediate values, such as 30.0:1.0 and 4.0:1.0 are also feasible.

In addition to the ratio of fracture factors disclosed above, the fracture factors of the first and second powders may be characterized by the difference between two fracture factors. For example, the fracture factor of the second powder may be at least one point greater than the fracture factor of the first powder. The difference between the two fracture factors could be two or even three fracture factor points.

Yet another way to characterize the difference in the fracture factor values is the numerical value of the fracture factor. For example, the fracture factor of the first powder could be 15.0 or higher, 20.0 or higher, or even 100. The fracture factor of the second powder could be at least 14.9 or less, 10.0 or less, 5.0 or less or even 0.

As used herein, the term “fracture factor” refers to a powdered material's ability to resist fracturing when exposed to a specific physical test. The fracture factor of a material is determined using a particle size analyzer, a dual asymmetric centrifugal mixer and the following process steps. First the particle size distribution of the material to be characterized is determined using a Horiba LA-950 Particle Size Analyzer which is available from Horiba Scientific, Edison, N.J., USA. This particle size distribution is defined as the initial particle size distribution. The initial distribution's d₉₀ is recorded. Second, an identical sample of the material with the same particle size distribution is placed into a plastic sample jar with a screw on lid. The jar measures approximately 5.3 cm in diameter and 7.0 cm long. The sample jar is then placed into a FlackTek Spectmixer™ DAC 150.1 FVZ-K which is available from FlackTek Inc. in Landrum, S.C., USA. The FlackTek Spectmixer™ is a dual asymmetric centrifugal mixer.

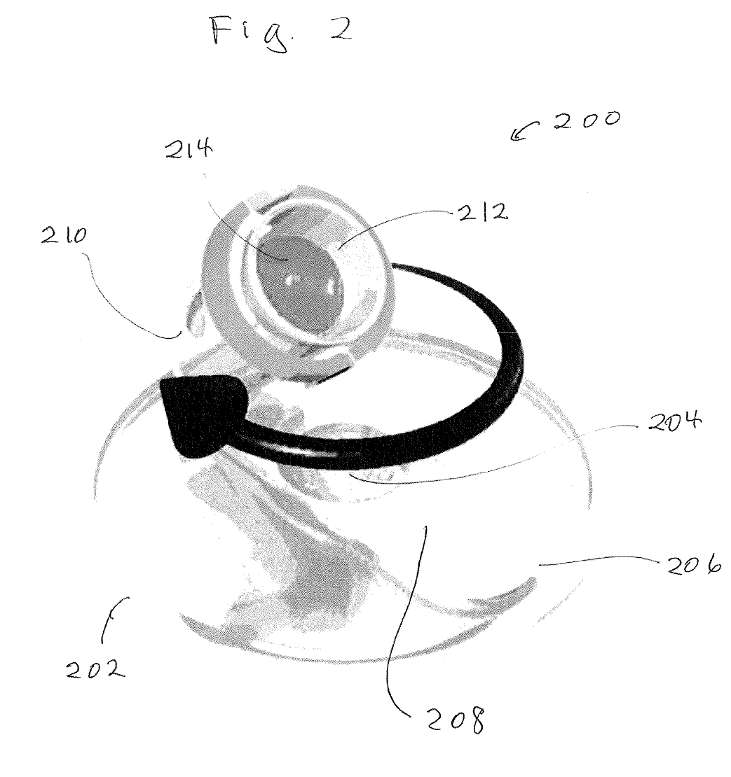

Shown in FIG. 2 is a perspective drawing of mixer 200 which includes the following components. Rotating base 202 secured to V-shaped support arm 206. The lower portion 208 of the support arm is secured to base 202. The upper portion 210 of arm 206 forms a basket 212 for holding sample jar 214. In operation, the mixer simultaneously rotates the sample jar around two separate axes. The first axis is perpendicular to and passes through the center of the base. The second axis passes through the longitudinal axis of the sample jar 214 when it is in cavity 212. When the mixer is operating, base 202 rotates clockwise about the first axis as the sample jar rotates counter clockwise around the second axis. The mixer has a single speed control which simultaneously controls the speed of rotation about the first axis and the second axis. In addition, the time that the material in the sample jar is spun is controlled by the operator. To determine a material's fracture factor the speed control is set at 3500 revolutions per minute and the time is set for one minute.

Third, after the sample jar has been spun for one minute at 3500 revolutions per minute the material is removed from the jar and the particle size distribution is measured using the Horiba particle size analyzer. This particle size distribution is designated the second particle size distribution and the d₉₀ is recorded. The fracture factor of the material is defined as the percent reduction in the d₉₀ value between the initial particle size distribution and the second particle size distribution. For example, if a material's initial d₉₀ is 50 microns and the second d₉₀ is 40 microns, then the absolute reduction is 10 microns which is 20% of the initial d₉₀. In this calculation the fracture factor is 20. In another example, if a material's initial d₉₀ is 50 microns and the second d₉₀ is 45 microns, then the absolute reduction is 5 microns which is 10% of the initial d₉₀. In this calculation the fracture factor is 10.

### EXAMPLES

Shown below is Table 1 are the data used to calculate the fracture factor for three powders, designated herein as powders A, B and C, that were then used to make mixtures for manufacturing ceramic carriers. Powder A was an alpha alumina powder. Powder B was corundum. Powder C was silicon carbide. The fracture factor was determined using the process described above. Specifically, the particle size distribution of each powder was measured using a Horiba LA-950 particle size analyzer. The initial d₉₀ of each powder was recorded. Identical samples of each powder were then inserted into separate sample cups that were sequentially inserted into a FlackTek Spectmixer™ DAC 150.1 FVZ-K dual asymmetric centrifugal mixer. The mixer was operated for one minute at 3500 revolutions per minute for each powder which was then removed from its sample cup. The d₉₀ of the particle size distribution was measured and recorded as the second particle size distribution. The absolute difference between the initial d₉₀ and the second d₉₀ was then calculated and divided by the initial d₉₀ to determine the fracture factor.

TABLE 1

| | | Initial | Second | Absolute | Fracture |
|---|---|---|---|---|---|
| Powder | Material | d₉₀ | d₉₀ | Difference | Factor |
| A | alpha alumina | 106 | 14 | 92 | 86.8 |
| B | corundum | 51 | 53 | 2 | 3.9 |
| C | silicon carbide | 107 | 104 | 3 | 2.8 |

The initial d₉₀, second d₉₀, and absolute difference were measured in microns. The fracture factor was determined by dividing the absolute difference by the initial d₉₀. The data clearly shows that the alpha alumina powder had a fracture factor well above 90 while the fracture factors of the corundum and silicon carbide were below 5.

Three mixtures for manufacturing ceramic carriers, designated herein as, Mixture 1, Mixture 2 and Mixture 3, were then made. All three mixtures contained the same weight percent of Powder A, which was an alpha alumina, plus other ingredients such as temporary binders, permanent bond material, a pore firmer, and water. Mixture 1 was the control mixture. Mixtures 2 and 3 were the experimental mixtures. All three mixtures contained the same ingredients except to that Mixture 2 contained 0.5 weight percent of Powder B and Mixture 3 contained 1.0 weight percent of silicon carbide. The coil value of each mixture was then determined using the process described above. Shown in the last row of Table 2 below is the additional wet mix time that was needed to achieve a similar coil value for each mixture.

TABLE 2

| | Mixture | | |
|---|---|---|---|
| | 1 | 2 | 3 |
| Powder A | yes | yes | yes |
| Powder B | no | yes | no |
| Powder C | no | no | yes |
| Additional Wet Mix Time (minutes) | 20 | 8 | 10 |

The data clearly shows that mixtures 2 and 3, which contained small quantities of powders B and C respectively, had wet mix times that were reduced by 50% or more compared to the wet mix time needed by mixture 1 to achieve essentially the same coil value. The substantial reduction in wet mix time is beneficial to commercial operations that process thousands of mixtures in a year as part of the carrier manufacturing process.

The specification and illustrations of the embodiments described herein are intended to provide a general understanding of the structure of the various embodiments. The specification and illustrations are not intended to serve as an exhaustive and comprehensive description of all of the elements and features of apparatus and apparatuses that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and to every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A mixture for manufacturing a ceramic carrier, said mixture comprises:
a. at least two comminuted materials comprising a first powder and a second powder, wherein the weight ratio of said first material to said second material is between 50:1 and 1000:1;
b. said first powder comprises at least 80 weight percent alumina and has a fracture factor of 15.0 or more; and
c. said second powder has a fracture factor of 14.9 or less.

2. The mixture of claim 1 wherein the fracture factor of said second powder is at least 1.0 less than the fracture factor of said first powder.

3. The mixture of claim 1 wherein said first powder has a fracture factor of 18.0 or more.

4. The mixture of claim 1 wherein said second powder has a fracture factor of 14.0 or less.

5. The mixture of claim 1 wherein said powders are uniformly dispersed within said mixture.

6. The mixture of claim 1 wherein the first powder represents at least 90 weight percent of the combined weight of the first and second powders.

7. The mixture of claim 1 wherein the weight ratio of said first powder to said second powder is at least 100:1 and no greater than 400:1.

8. The mixture of claim 1 wherein said second material is selected from the group consisting of silicon carbide and corundum.

9. The mixture of claim 1 wherein said mixture further comprises at least 20 weight percent organic additives, said percentage based on the combined weight of the first and second powders.

10. A process for manufacturing a ceramic component, said process comprising:
a. providing an first powder comprising a plurality of individual free flowing particles, said first powder having a fracture factor of 15.0 or more;
b. providing a second powder comprising a plurality of individual free flowing particles, said second powder has a fracture factor of 14.9 or less; and
c. mixing said powders for an initial period of time (T₁) thereby forming a first mixture and wherein said first mixture has a moisture content less than 2 weight percent based on the weight of said powders.

11. The process of claim 10, wherein the fracture factor of said first powder is equal to or greater than 17.0.

12. The process of claim 10, wherein the fracture factor of said first powder is equal to or less than 50.0.

13. The process of claim 10, wherein the fracture factor of said second powder is equal to or less than 14.0.

14. The process of claim 10, wherein the fracture factor of said second powder is equal to or greater than 2.0.

15. The process of claim 10, wherein said process further comprises: adding water and at least one component selected from the group consisting of bond materials, pore formers and extrusion aids to said first mixture thereby forming a wet mixture.

16. The process of claim 15 further comprises mixing said wet mixture for a second period of time (T₂).

17. The process of claim 16 further includes extruding said wet mixture through a die to form a plurality of greenware particles.

18. The process of claim 17 further includes the process of drying said greenware particles.

19. The process of claim 18 further includes sintering said dried greenware thereby forming sintered ceramic components.

20. The process of claim 16 wherein said second mixing time (T₂) is at least 10 percent less than the time needed to mix an identical wet mixture to the same coil except that the identical wet mixture contains an equivalent weight of said first powder in place of said second powder.

21. The process of claim 20 wherein said mixing time is at least 15 percent less.

22. The process of claim 20 wherein said mixing time is at least 20 percent less.

23. A process for manufacturing a ceramic component, said process comprising:
a. providing an first powder comprising a plurality of individual free flowing particles, said first powder having a fracture factor of at least 15.0;
b. providing a second powder comprising a plurality of individual free flowing particles, said second powder having a fracture factor of 14.9 or lower;
c. mixing said powders for an initial period of time (T₁) thereby forming a first mixture wherein said first mixture has a moisture content less than 2 weight percent;
d. adding water and at least one component selected from the group consisting of bond materials, pore formers and extrusion aids to said first mixture thereby forming a composition; and
e. mixing said composition for a second period of time (T₂) thereby forming a wet mixture that has a final coil value, wherein said second mixing time (T₂) is at least 10 percent less than the time needed to mix an identical wet mixture to the same coil value except that the identical wet mixture contains an equivalent weight of said first material in place of said second material.
